(19) United States
(12) Patent Application Publication
(10) Pub. No.: US 2006/0130045 A1
(43) Pub. Date: Jun. 15, 2006

(54) Systems and methods for dynamically updating computer systems

(76) Inventors: Jonathan Wesley, Bountiful, UT (US); Ryan Sealy, Layton, UT (US); Nathan Daniels, Woods Cross, UT (US)

Correspondence Address: KIRTON AND MCCONKIE;1800 EAGLE GATE TOWER, 60 EAST SOUTH TEMPLE, P O BOX 45120, SALT LAKE CITY, UT, 84145-0120, US

(21) Appl. No.: 11/283,486

(22) Filed: Nov. 18, 2005

Related U.S. Application Data
(60) Provisional application No. 60/629,646, filed on Nov. 19, 2004.

(51) Int. Cl. G06F 9/44

(52) U.S. Cl. 717/168

(57) ABSTRACT

Systems and methods for intelligently trickle-feeding a computer system with needed software without over-consuming available bandwidth to allow the software update to occur in the background and to minimize the impact of the update on a user of the computer system. A determination is made as to whether or not the software update is needed. The type of network is also determined, including the amount of bandwidth that is available for transmission of the software update to the client computer device. An intelligent determination is made relating to how much of the update to send at a time and the rate of sending information chunks in order to trickle-feed the needed update to the client computer device. Confirmation information is exchanged relating to a completed update. If an unsuccessful or partial update occurs, a retransmission of only the needed chunks is performed to minimize the amount of data transfer needed to rectify the problem or completely install the update.

### RELATED APPLICATIONS

This application claims priority to U.S. Provisional Patent Application Ser. No. 60/629,646 filed Nov. 19, 2004, entitled SYSTEMS AND METHODS FOR DYNAMICALLY UPDATING COMPUTER SYSTEMS.

### BACKGROUND OF THE INVENTION

1. Field of the Invention

The present invention relates to dynamically updating computer systems. In particular, the present invention relates to systems and methods for intelligently trickle-feeding a computer system with needed software (e.g., a software update, patch and/or full installation) without over-consuming available bandwidth to allow the software update to occur in the background and to minimize the impact of the update on a user of the computer system.

2. Background and Related Art

With technology advancing in the computer industry, the hardware devices and software applications that are currently available have increased capabilities. However, due to rapid improvement of software applications and increased user sophistication, the software applications are required to be frequently updated on an ongoing basis.

One such area requiring software updates relates to virus protection. A virus is a program or piece of code that is loaded onto a user's computer without the user's knowledge and runs against the user's wishes. A self-replicating virus can quickly use all available memory and bring the computer to a halt. An even more dangerous type of virus is one that is capable of transmitting itself across networks and bypassing security systems. Accordingly, virus protection software applications are continually being written or updated to protect computer systems from viruses.

While updating a computer system can prove beneficial, the process of updating software or downloading computer applications can be frustrating, time consuming and inconvenient. For example, users become frustrated during a software download or update when they are unable to use their computers until the software download or update is complete. In order to minimize the impact on users, computer support individuals are often required to perform the software downloads or updates during non-business hours. This can mean that when a system having a large number of computers networked together needs to receive one or more software downloads or updates, the individuals performing the downloads or updates are required to perform them over the weekend, late at night and/or early in the morning to minimize the impact on the users.

Thus, while techniques currently exist that are used to update computer systems, challenges still exist. Accordingly, it would be an improvement in the art to augment or even replace current techniques with other techniques.

### SUMMARY OF THE INVENTION

The present invention relates to dynamically updating computer systems. In particular, the present invention relates to systems and methods for intelligently trickle-feeding a computer system with needed software (e.g., a software update, patch and/or full installation) without over-consuming available bandwidth to allow the software update to occur in the background and to minimize the impact of the update on a user of the computer system.

Implementation of the present invention takes place in association with a plurality of computer and/or digital devices. For example, a software update may be available for a software application at a client computer device or other digital device. Accordingly, during connection of the client device with a server computer device, a determination is made as to whether or not the software update is needed. The type of network is determined, including the amount of bandwidth that is available for transmission of the software update to the client device. An intelligent determination is made relating to how much of the update to send at a time and the frequency of sending data packets or chunks, for example, in order to trickle-feed the needed update to the client device. Thus, the update is provided to the client device without interruption of the user at the client device.

As part of the updating process, a confirmation is exchanged when the update was completely received and installed. If, for example, the connection is interrupted during transmission of the software update, a determination is made as to the data packets or chunks that were not received or installed. A retransmission of only the needed data packets or chunks minimizes the amount of data transfer needed to rectify the problem and completely install the update. This is particularly valuable when the update is being transmitted over an unstable network, such as a wireless network, where the transmission can be interrupted.

While the methods and processes of the present invention have proven to be particularly useful in the area of software updates, those skilled in the art will appreciate that the methods and processes can be used in a variety of different applications, including software patches, bug fixes, full or partial installations, or any other type of data transfer to minimize the impact of the update on a user of the computer system. Further, while the methods and processes of the present invention have proven to be useful in client-server system configurations, those skilled in the art will appreciate that the methods and processes can be used in a variety of system configurations, including peer to peer system configurations, etc., in order to disseminate or otherwise provide a software upgrade, application instillation, or data transfer.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative system that provides a suitable operating environment for use of the present invention;

FIG. 2 illustrates a representative system configuration that may be used in accordance with embodiments of the present invention; and

FIG. 3 illustrates other representative system configurations and representative methods for dynamically updating computer systems in accordance with embodiments of the present invention.

### DETAILED DESCRIPTION OF THE INVENTION

The present invention relates to dynamically updating computer systems. In particular, the present invention relates to systems and methods for intelligently trickle-feeding a computer system with needed software (e.g., a software update, patch and/or full installation) without over-consuming available bandwidth to allow the software update to occur in the background and to minimize the impact of the update on a user of the computer system.

Embodiments of the present invention take place in association with a plurality of computer devices. For example, a software update may be available for a software application at a client computer device. Accordingly, during connection of the client computer device with a server computer device, a determination is made as to whether or not the software update is needed. The type of network transmission is determined, including the amount of bandwidth that is available for transmission of the software update to the client computer device. In one embodiment, the determination of the transmission used is based on the reliability, such as the most reliable transmission or a more reliable transmission. In another embodiment, the determination of the transmission used is based upon the highest available frequency. An intelligent determination is made relating to how much of the update to send at a time and the rate of sending data packets or chunks, for example, in order to trickle-feed the needed update to the client computer device. Thus, the update is provided to the client without interruption of the user at the client computer device, as will be further discussed below.

The following disclosure of the present invention is grouped into two subheadings, namely “Exemplary Operating Environment” and “Dynamically Updating Computer Systems.” The utilization of the subheadings is for convenience of the reader only and is not to be construed as limiting in any sense.

### Exemplary Operating Environment

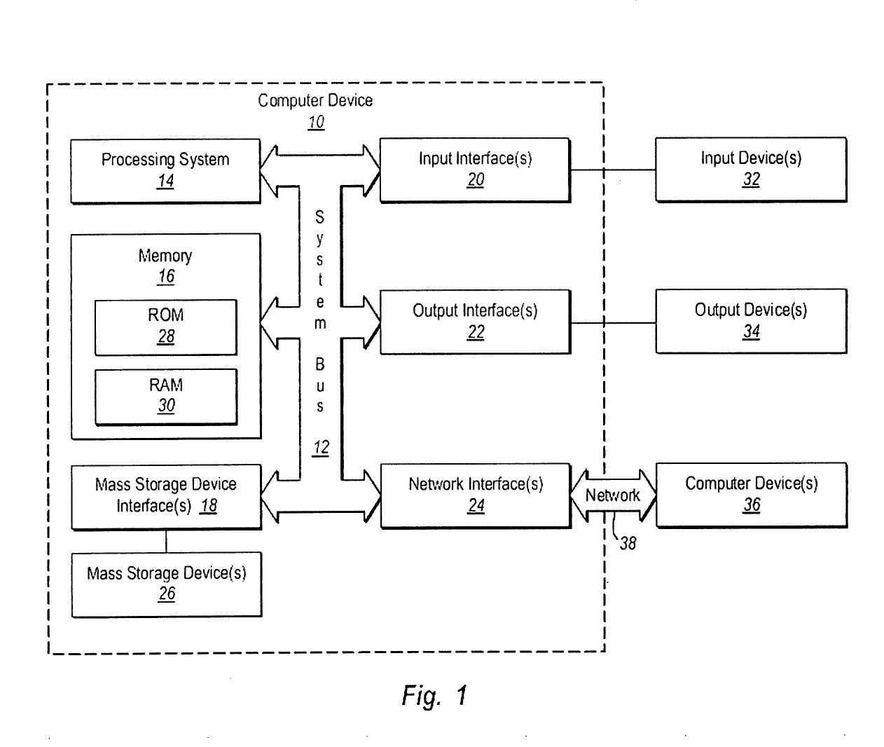

FIG. 1 and the corresponding discussion are intended to provide a general description of a suitable operating environment in which the invention may be implemented.

One skilled in the art will appreciate that the invention may be practiced by one or more computing devices and in a variety of system configurations, including in a networked configuration.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing the invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

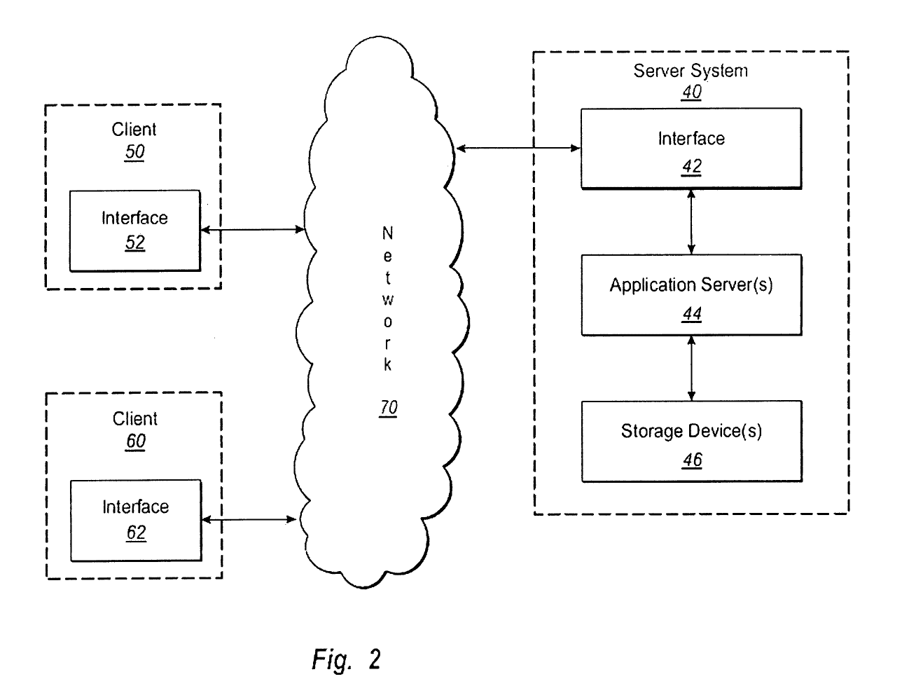

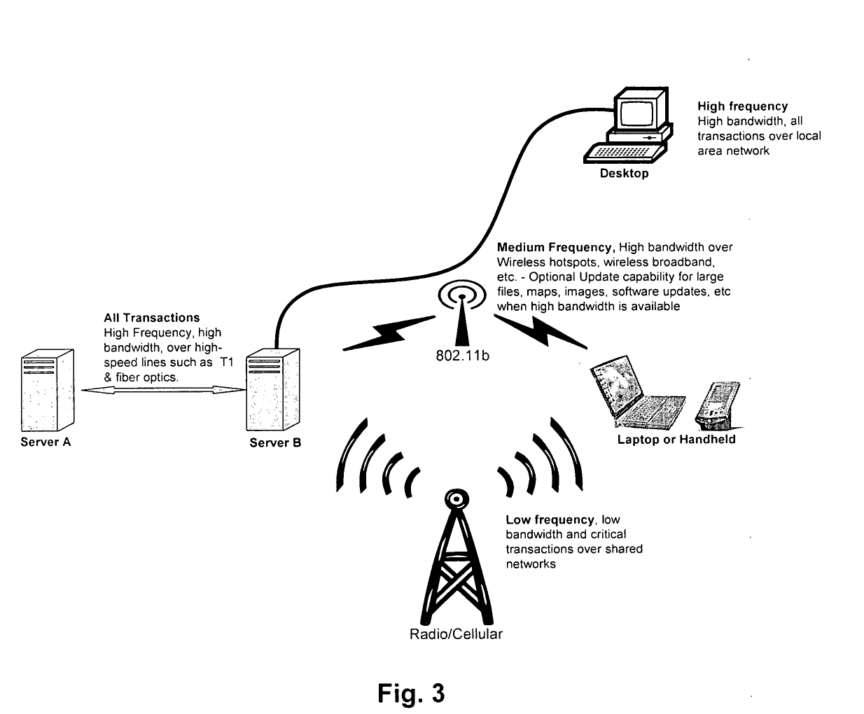

While those skilled in the art will appreciate that the invention may be practiced in networked computing environments with many types of computer system configurations, FIGS. 2-3 illustrate representative system configurations. For example, FIG. 2 represents an embodiment of the present invention that enables a server system to dynamically and intellectually upgrade software, install software, provide a software fix/patch, or otherwise transfer data or information to one or more client computer devices in accordance with an embodiment of the present invention.

While FIG. 2 illustrates an embodiment that includes two clients connected to the network, alternative embodiments include one client connected to a network or many clients connected to a network. Moreover, embodiments in accordance with the present invention also include a multitude of clients throughout the world connected to a network, where the network is a wide area network, such as the Internet. Further, embodiments of the present invention include a variety of mediums used for the transmission of data, including hardwired connections, wireless connections, radio connections, satellite connections, stable connections, unstable connections, etc.

In FIG. 2, server system 40 represents a system configuration that includes one or more servers that may be used to implement methods and/or processes disclosed herein. While FIG. 2 illustrates the use of a server system 40, those skilled in the art will appreciate that methods and/or processes of the present invention may be performed by the use of a single computer device or without the use of a computer device. Thus, by way of example, server system 40 may be a single server in cases where a single server can process and preserve the entire amount of information required to perform the methods and systems of the present invention, as will be further explained below. Alternatively, server system 40 may be a conglomeration of servers that process and preserve a high volume of information. Moreover, in some embodiments the servers interact in a peer-to-peer manner and automatically update each other to maintain current information.

The following is a discussion of an embodiment of the present invention that includes a plurality of clients, illustrated as clients 50 and 60, which are connected to server system 40 across network 70, and receive an intelligent trickle-feeding of needed software or information (e.g., a software update, software patch, partial installation, full installation, data transmission, etc.) without over-consuming available bandwidth to allow the software update to occur in the background and to minimize the impact of the update on a user of the computer system.

With reference to FIG. 2, clients 50 and 60 each include an interface (respectively illustrated as interfaces 52 and 62). Network interface 52 is a communication mechanism that allows a client (client 50) to communicate to server system 40 by a network 70, such as the Internet or another network configuration.

Server system 40 includes interface 42, peer application servers 44, and storage device 46. Interface 42 is a communication mechanism that allows server system 40 to communicate with one or more clients by a network 70. Application servers 44 include one or more servers for processing and/or preserving information. Storage device 46 includes one or more storage devices for preserving information, such as data, objects and/or other information to perform the methods enclosed herein. Storage device 46 may be internal or external to application servers 44.

As will be further discussed below, server system 40 intelligently trickle-feeds clients 50 and 60 with needed software (e.g., a software update, patch and/or full installation) without over-consuming available bandwidth across the network to allow the software update to occur in the background and to minimize the impact of the update on users at clients 60 and 60.

While the discussion above has presented a representative system configuration that may be used to implement methods and/or processes of the present invention, those skilled in the art will appreciate that the methods of the present invention and processes thereof may be implemented in a variety of different system configurations.

For example, at least some embodiments of the present invention embrace dynamically updating a computer device and/or computer system in a data sharing network that provides real time critical data access from any integrated data source to any authorized individual or system using any integrated computer system, application, or device. In at least some embodiments all clients, servers, requests for data, and their associated means of communications and transmission throughout a data sharing network are highly functional over countless disparate computer systems, databases, standards, protocols, formats, applications, devices, and networks. The data sharing network is a highly scalable, secure, interoperable multi-system peer-to-peer network that utilizes methods and processes associated with dynamically accessing, converting, and transmitting data over networks in real time from disparate data sources to disparate client systems, applications, and devices. The open standards-based nature of the particular architecture, in association with the powerful capabilities of its core and utility components, allows breakthrough integration speeds with today's disparate systems and sets the stage for future expansion both in terms of the network itself and the needs of current and future peer members.

In at least some embodiments, the data sharing network is not dependent of any particular operating system, application, or device, and provides maximum flexibility and customization to accommodate differing needs of peer members within a network, while maintaining the integrity of the overall system functionality. The data sharing network removes significant technological barriers that previously precluded disparate data systems from working together as one. Examples of such barriers relate to authorization and access control management across business, government, and/or jurisdictional entities, maintaining local control over a database without replicating to a central data warehouse, limits on scalability, end-user accountability, addressing variances in hardware limitations (bandwidth/processing power), hardware disparity, operating system disparity, database disparity, network disparity, protocol standards disparity, application disparity, and the like. In one data sharing network environment, data flow occurs by request or by a push from an external system to provide for dynamic updating of computer devices and/or systems, as will be further discussed below.

### Dynamically Updating Computer Systems

As provided above, embodiments of the present invention relate to dynamically updating computer systems. In particular, embodiments of the present invention relate to systems and methods for intelligently trickle-feeding a computer system with needed software (e.g., a software update, patch and/or full installation) without over-consuming available bandwidth to allow the software update to occur in the background and to minimize the impact of the update on a user of the computer system.

There exists an ongoing need as technology advances to update or install software. During an update, such as to provide virus protection, to provide an operating system update, or the like, if the connection is a wireless connection the user has typically been limited on processing power to perform other processing functions. This is because the operating system uses as much as possible of the available bandwidth for the update or download. However, in accordance with at least some embodiments of the present invention, methods and processes are provided that run on the computer device in the background that trickle-feed the update or download.

At least some embodiments of the present invention relate to a client/server technology that dynamically auto-updates computer devices and/or systems and associated digital devices with computer programs and other relevant data. For example, this includes but is not limited to the technology to software updates, patches, and full installations. An embodiment automatically detects disparate public and/or private radio networks, and intelligently utilizes available networks to dynamically transmit appropriately-sized data packets/chunks of information in a trickling-feeding method. Accordingly inordinate amounts of available bandwidth are not consumed. Embodiments know when to send data, and how much data to send based upon available public and/or private networks. Data may be sent over secure sockets in any protocol and format that the receiving client requires. Based upon access control lists and applicable business rules, authenticated users can access system programs, documents, files, and other authorized job-related data. Functions are performed as if in the background, allowing other prioritized data transactions to utilize the necessary bandwidth for job-critical needs. User intervention is not necessary on the client side, and packet sizes are selectively altered to conform to the capabilities of available network devices. Additionally, the frequency of data transmission is selectively altered based upon the network device capability. The capability to enable, disable, and/or restrict is available.

At least some embodiments of the present invention relate to a technology that dynamically auto-updates computer systems and/or devices and other digital devices with the latest versions of computer programs and other relevant data. Embodiments dynamically install applications on computer devices and/or systems and other digital devices, and utilize available radio networks and their associated bandwidths, and send appropriately-sized data packets by trickling-feeding the data.

Embodiments of the present invention further relate to intelligent detection of available networks and segregating, disabling, enabling, and conforming transactions to meet the capabilities of the available network device(s), and auto-publishing of installations, setups, and any other type of data to required systems over disparate network devices. Further, embodiments of the present invention enable, disable, and/or alter packet size and/or frequency of transmission depending upon the capability of the network device.

In at least one embodiment, a client device checks with a server for the determination as to whether or not updates are needed on the client. A service manages the updates instead of the operating system. The service connects to the server and identifies the client and the client applications. The server then provides a unique identification number to the client and the client uses the identification number to determine if any request needs to be made for updating or installing software on the client.

If a request is made, the client receives a trickle-feed of the update to cause the update to be performed in the background and to minimize any effect on the user during the update/download. The trickle-feed is a spoon feed of the update based upon the type of network that is being used. So, if it is a wireless network and is running at something comparable to a 28.8 modem, the update is trickle-fed so that it doesn't impact the network connection. This allows the user to continue working with the available applications. Thus, during the update, the user can browse the web, check email, run mobile software, run reports, etc.

In contrast, when a high-speed connection is detected, such as a high speed 802.11 hot spot network, the service rolls over and uses the high-speed connection and apportions an amount less than full available capacity (e.g., half or another amount) to use for the download. Thus, the trickle feed in the present example may be coming in at approximately 500 bytes per second or 1 k a second depending on the computer device and then when the high-speed connection is detected it will suddenly go to 50 meg per second. Thus, in accordance with at least some embodiments of the present invention, an upgrade/download is trickle-fed for an enhanced use of over narrow bandwidth, including over disparate types of networks.

In at least one embodiment, the type of network connection is detected automatically and thus will gauge how fast to have the server send information to the client. The trickle-feed relates to how fast the information is transmitted and the size of each chunk of information. Further, embodiments of the present invention embrace providing an update/download over a radio network. The service is able to compensate for delays and instability. Thus, for example, each time the service initiates a data packet transfer, it includes a predetermined delay (e.g., two seconds or other amount). So, the service may request 512 bytes at 5 second intervals instead of 256 bytes every 2 seconds to prevent the formation of a large queue of information.

With reference now to FIG. 3, a representative embodiment is provided. In FIG. 3, all data transactions are provided in accordance to an embodiment of the present invention between servers across high frequency, high bandwidth transmissions. Examples of high frequency, high bandwidth mediums include high speed mediums/lines such as T1 connections, fiber optics, etc. If a transmission needs to be made across a low frequency medium, the update is trickle-fed across the available connection. Examples of low frequency mediums include radio, cellular and other mediums, including low bandwidth mediums over shared networks. If a higher frequency transmission is alternatively available, the update is trickle-fed across the higher frequency. In any case, however, the trickle-feed uses less that the total available bandwidth to allow the transmission of data to take place in the background and to minimize the impact on the user.

Medium frequency, high bandwidth mediums may be available for use. Examples may include wireless hotspots, wireless broadband, etc. In such situations, update capability may be available in accordance with embodiments of the present invention for a transfer of information, including large files, maps, images, software updates, etc.

The trickle-feed controls the packet size. For example, in one embodiment, the packet size is pre-determined according to the type of network connection that is detected to optimize the data transfer. It is easily definable so that the service can specify what type of connection it is and the best way to transfer data over that type of network.

The verification process occurs over the socket layer. A check is performed from an MD5, or other hash algorithm, value that is passed along with the data. Thus, if the update is not completed or an error occurs, only the particular packet(s) that are needed are re-requested.

In at least some embodiments, the trickle-feed includes checks to determine if the update, download or data transfer is complete. Thus, a user can unplug a device from the network and later plug the device back into the network, and the service continues resuming the download exactly where it left off. Further, the user can turn the power off and then when it is turned back on it will resume exactly where it left off so nothing is wasted.

In accordance with at least some embodiments, the service is software independent so that it doesn't need to be a particular application. Instead, it is a structure that is established. Thus, for example, a profile is created for the server, and then when the client makes the request to the server, it has some basic information that is exchanged with the server, such as the type and version of the operating system. The determination of the update may then include that an update is needed on a particular application and that the application will function with the available operating system. Thus, when the version of the application corresponds with the available operating system, nothing needs to be done in addition. But, if the version number is actually a special type of file that examines the history when files are transferred or when requests are made for a directory structure, it creates empty values and those unique values are passed to the server. However, because you don't want to send those values over and over again due to the waste of packets, the service sends versioning values. So, from the last time the service successfully did an update, it can be known how many updates the client is behind and at what point to do an update.

In addition, embodiments of the present invention can determine whether it is preferred to provide an update or alternatively provide a download of the entire application.

Thus, embodiments of the present invention do more than only update applications. Instead, they are able to update whatever application desired. Thus, developers don't have to incorporate any way of doing software updates. All they have to do is to copy the files they want on the server in the quick directory structure and then all of the clients that use the server can automatically get updated and you don't have to worry about eating up their network bandwidth because it will be pushed and trickle-fed to each one. Accordingly, embodiments of the present invention embrace automatic propagation of updates/installations to all the other users.

Further, embodiments will queue client download. For example, a determination is made as to the availability of each client. The various updates/downloads are made or completed as the clients are available to balance the load.

Further, embodiments of the present invention embrace updating a particular software application while the application is being used by the client. For example, a determination is made that the application is in use and the update is still trickle-fed to the client while the application is in use. Once the application is not in use, the updated information, which has already been received by the client, is applied to the application to update the application.

In at least some embodiments, when an update gets stopped part way through and then it is resumed, rather than the service needing to look at the drive to see how much is left and then start from that point, there is an artificial file structure that is created locally so that when as each packet or chunk is complete then a corresponding tag is placed.

In accordance with embodiments of the present invention, the update that is made on a computer device can be a version upgrade, a bug fix or a complete application download. And, due to the trickle-feed, the update will be provided in the background to still allow the user to utilize the client, and will dynamically allow the update to be provided whenever the client is available—even resuming at the precise point needed if the connection is unavailable for a period of time. And, with each process it logs that it has been completed so that it is known that each chunk is successful, and that the entire update is complete. System managers are able to know which clients have completed the update, and the amount of the update completed at each computer device of a particular system.

In one embodiment, the update is initiated by an email sent to each client device, wherein the email includes a link that is selected by the user at the client device. The selection of the link causes the update to be trickle-fed to cause the update to be provided in the background to still allow the user to utilize the client, and will dynamically allow the update to be provided whenever the client is available.

Thus, embodiments of the present invention embrace the ability to trickle feed the updates so it doesn't impact the network. Embodiments also embrace the ability to detect and use different networks or concurrent networks for the update. Embodiments also allow for the use of versioning controls. Embodiments further embrace the ability for supporting any number of applications. Moreover, embodiments embrace for the updates to be encrypted so the information is being sent across securely without decipherable interception and/or change to the data packets. Embodiments include authentication so that the server verifies the delivery and access of files. Embodiments use certificates so applications can register to be able to work on the client and server. Embodiments embrace the ability to propagate an update from one server to many servers to help distribute the transfer of information. Further, if a server is busy, the client can be transferred to another server for the update to occur.

Moreover, embodiments embrace for the updates to be encrypted so the information is being sent across but nobody can go and intercept and/or change the data packets. Embodiments include authentication so that the service verifies that you're allowed to get those files. Embodiments use certificates so applications can register to be able to work on the client and server. Embodiments embrace the ability to propagate an update from one server to many servers to help distribute the transfer of information. Further, if a server is busy, the client can be transferred to another server for the update to occur.

While at least some embodiments discussed herein relate to trickle feeding information from a server to a client, those skilled in the art will appreciation that embodiments of the present invention embrace trickle feeding information from a client to a server. Additionally, those skilled in the art will appreciate that embodiments of the present invention embrace trickle feeding information from one computer device to another computer device, wherein the computer configuration is not a client/server configuration.

Accordingly, in one embodiment of the present invention, information at a server is updated. A client may be unable to communicate with a server or other computer device at a particular instant in time. Accordingly, the client continuously or periodically checks for the ability to transfer information. The user at the client can continue to use the client, and when there is the ability to transfer information, a determination is made as to the type of connection and/or transmission medium that is available. Parameters are established relating to the amount of information that is provided. The information is trickle fed to the server or other computer device. Additionally, unique identifiers are used that are specific to particular information or reports. And, a determination is made as to whether or not all of the information has been transferred.

Thus, as discussed herein, the embodiments of the present invention embrace dynamically updating computer systems. In particular, the present invention relates to systems and methods for intelligently trickle-feeding a computer device and/or system with needed software (e.g., a software update, patch and/or full installation) or information without over-consuming available bandwidth to allow the software update to occur in the background and to minimize the impact of the update on a user of the computer system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method for dynamically updating a computer system, the method comprising:
determining whether an update is needed at a computer device;
determining the type of transmission medium that is to be employed for transmitting the update;
establishing parameters of providing chunks of information as the update to the computer device;
transmitting the chunks of information as a trickle-feed to the computer device;
determining if each of the chunks of information were successfully completed; and
if any of the chunks of information were not successfully completed, retransmitting only the unsuccessful chunks to complete the update.

2. A method as recited in claim 1, wherein the update is a software patch.

3. A method as recited in claim 1, wherein the update is a full installation of a software application.

4. A method as recited in claim 1, wherein said transmitting the chunks of information as a trickle-feed to the computer device is performed using less than the total available bandwidth amount.

5. A method as recited in claim 1, wherein said determining the type of transmission medium that is to be employed for transmitting the update comprises identifying whether the transmission medium comprises at least one of (i) a high frequency transmission medium, (ii) a medium frequency transmission medium, and (ii) a low frequency transmission medium.

6. A method as recited in claim 5, wherein said transmitting the chunks of information as a trickle-feed to the computer device comprises at least one of:
(i) utilizing the transmission medium with the highest available frequency transmission; and
(ii) utilizing the transmission medium based on reliability.

7. A method as recited in claim 5, wherein said transmitting the chunks of information as a trickle-feed to the computer device comprises utilizing multiple available transmission media.

8. A method as recited in claim 1, wherein said determining the type of transmission medium that is to be employed for transmitting the update comprises detecting disparate networks.

9. A method as recited in claim 1, wherein said transmitting the chunks of information as a trickle-feed to the computer device comprises transmitting the chunks of information over secure sockets in any protocol and format that is understood by the computer device.

10. A method as recited in claim 1, wherein said establishing parameters of providing chunks of information as the update to the computer device comprises at least one of:
(i) altering packet sizes based on capabilities of an available network; and
(ii) altering a frequency of data transmission based on capabilities of the available network.

11. A method as recited in claim 1, wherein said determining if each of the chunks of information were successfully completed is performed over a socket layer.

12. A method for dynamically updating a computer device, the method comprising:
determining whether information is needed to be transmitted to a computer device;
determining a type of transmission medium that is available to be employed for transmitting the information;
establishing parameters of providing information chunks to transmit the information;
transmitting the information chunks as a trickle-feed to the computer device;
determining if each of the information chunks were successfully completed; and
if any of the information chunks were not successfully completed, retransmitting only unsuccessful information chunks to complete the update.

13. A method as recited in claim 12, wherein said transmitting the information chunks as a trickle-feed to the computer device is performed using less than a total available bandwidth amount.

14. A method as recited in claim 12, wherein said determining a type of transmission medium that is available to be employed for transmitting the information comprises identifying whether the transmission medium comprises at least one of (i) a high frequency transmission medium, (ii) a medium frequency transmission medium, and (ii) a low frequency transmission medium.

15. A method as recited in claim 14, wherein said transmitting the information chunks as a trickle-feed to the computer device comprises at least one of:
(i) utilizing the transmission medium with the highest available frequency transmission; and
(ii) utilizing the transmission medium based on reliability.

16. A method as recited in claim 14, wherein said transmitting the information chunks as a trickle-feed to the computer device comprises utilizing multiple available transmission media.

17. A method as recited in claim 12, wherein said establishing parameters of providing information chunks to transmit the information comprises at least one of:
(i) altering packet sizes based on capabilities of an available network; and
(ii) altering a frequency of data transmission based on capabilities of the available network.

18. A computer program product for implementing within a computer system a method for updating a computer device, the computer program product comprising:
a computer readable medium for providing computer program code means utilized to implement the method, wherein the computer program code means is comprised of executable code for implementing the steps of:
automatically determining whether an update is needed at a computer device and the type of transmission medium that is available for transmitting the update;
establishing parameters relating to the providing of chunks of information as the update to the computer device;
transmitting the chunks of information as a trickle-feed to the computer device;
determining if each of the chunks of information were successfully completed; and
if any of the chunks of information were not successfully completed, retransmitting only the unsuccessful chunks to complete the update.

19. A computer program product as recited in claim 18, wherein said establishing parameters of providing chunks of information as the update to the computer device comprises at least one of:
(i) altering packet sizes based on capabilities of an available network; and
(ii) altering a frequency of data transmission based on capabilities of the available network.

20. A computer program product as recited in claim 19, wherein said determining if each of the chunks of information were successfully completed is performed over a socket layer.
